(19) United States
(12) Patent Application Publication
(10) Pub. No.: US 2005/0114514 A1
(43) Pub. Date: May 26, 2005

(54) Advising a network component for control of communication session connection through employment of one or more communication session restrictions

(76) Inventors: Kevin L. Bostrom, Naperville, IL (US); Gerald W. Pfleging, Batavia, IL (US); George Paul Wilkin, Bolingbrook, IL (US)

Correspondence Address: PATTI & BRILL, ONE NORTH LASALLE STREET, 44TH FLOOR, CHICAGO, IL, 60602, US

(21) Appl. No.: 10/719,453

(22) Filed: Nov. 21, 2003

(51) Int. Cl. G06F 15/16

(52) U.S. Cl. 709/227

(57) ABSTRACT

An application server component of an apparatus that serves to maintain one or more communication session restrictions set by one or more administrators for one or more mobile communication devices. The application server component employs one or more of the one or more communication session restrictions to advise one or more network components for control of one or more connections of one or more communication sessions for one or more of the one or more mobile communication devices.

### CROSS-REFERENCE TO RELATED APPLICATIONS

This application contains subject matter that is related to the subject matter of the following application, which is assigned to the same assignee as this application. The below-listed application is hereby incorporated herein by reference in its entirety:

“COMMUNICATION DEVICE EMPLOYMENT OF ONE OR MORE RESTRICTIONS TO MAKE DETERMINATION OF ALLOWABILITY OF ONE OR MORE COMMUNICATION SESSIONS,” by Florkey et al., Ser. No. 10/609861, filed Jun. 30, 2003.

### TECHNICAL FIELD

The invention relates generally to telecommunications and more particularly to communication session restrictions.

### BACKGROUND

Users of communication devices desire to communicate in communication sessions. A user of a first communication device of the communication devices in one example desires to restrict usage of a second communication device of the communication devices. For example, the user of the first communication device may share a relationship with a user of the second communication device. The user of the first communication device in one example comprises a parent and the user of the second communication device comprises a child. The parent may wish to restrict the use of the second communication device by the child. The first communication device and the second communication device in one example comprise mobile phones, personal digital assistants, soft phones, or computers.

The user of the first communication device may wish to set one or more restrictions of one or more communication sessions for the user of the second communication device. The second communication device in one example stores the restrictions of the communication sessions. The second communication device in one example employs the restrictions to determine whether a communication session is allowable. For example, the second communication device employs the restrictions to block or allow incoming calls, outgoing calls, email usage, instant message usage, short message service usage (“SMS”), and Internet usage. The second communication device comprises specialized usage restriction software to store and use the restrictions. As one shortcoming, mobile phones without the specialized usage restriction software cannot employ restrictions to restrict the communication sessions. Also, the restrictions for the second communication device may not allow the user of the second communication device to bypass the restrictions. As another shortcoming, in an emergency situation, the user may not be able to employ the second communication device to call for help.

Thus, a need exists for usage restriction for a mobile communication device that doesn't require the mobile communication device to have specialized usage restriction software.

### SUMMARY

The invention in one implementation encompasses an apparatus. The apparatus comprises an application server component that serves to maintain one or more communication session restrictions set by one or more administrators for one or more mobile communication devices. The application server component employs one or more of the one or more communication session restrictions to advise one or more network components for control of one or more connections of one or more communication sessions for one or more of the one or more mobile communication devices.

Another implementation of the invention encompasses a method. One or more administrators set one or more communication session restrictions that are maintained for one or more mobile communication devices. One or more network components are advised for control of one or more connections of one or more communication sessions for one or more of the one or more mobile communication devices through employment of one or more of the one or more communication session restrictions.

A further implementation of the invention encompasses an article. The article comprises one or more computer-readable signal-bearing media. The article includes means in the one or more media for maintaining one or more communication session restrictions set by one or more administrators for one or more mobile communication devices. The article includes means in the one or more media for advising one or more network components for control of one - or more connections of one or more communication sessions for one or more of the one or more mobile communication devices through employment of one or more of the one or more communication session restrictions.

### DESCRIPTION OF THE DRAWINGS

Features of exemplary implementations of the invention will become apparent from the description, the claims, and the accompanying drawings in which:

FIG. 1 is a representation of an exemplary implementation of an apparatus that comprises one or more communication devices, one or more application server components, one or more network components, and one or more mobile communication devices.

FIG. 2 is a representation of exemplary logic that serves to allow the application server component to employ the communication session restrictions to advise the network component for control of the communication sessions of the mobile communication device of FIG. 1.

### DETAILED DESCRIPTION

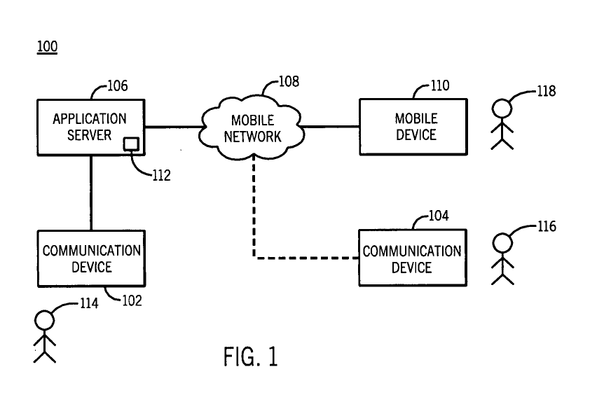

Turning to FIG. 1, an apparatus 100 in one example comprises one or more communication devices 102 and 104, one or more application server components 106, one or more network components 108, and one or more mobile communication devices 110. An administrator 114 of the communication device 102 in one example sets one or more communication session restrictions for the mobile communication device 110. For example, the administrator 114 employs the communication device 102 to set the communication session restrictions at the application server component 106. A user 118 of the mobile communication device 110 in one example attempts to conduct a communication session with a user 116 of the communication device 104. The application server component 106 employs the communication session restrictions to advise the network component 108 for control of one or more connections of the communication session for the mobile communication device 110.

The administrator 114 of the communication device 102 in one example sets the communication session restrictions to allow or restrict the connection of the communication session for the mobile communication device 110. The communication sessions in one example comprise one or more of an email, a phone call, website access, an instant message, a short message service message, and a multimedia message. The user 118 employs the mobile communication device 110 to communicate with the user 116 of the communication device 104 in the communication session. The communication session restrictions in one example comprise one or more of a time limit restriction, a session limit restriction, a user limit restriction, and a website limit restriction.

The administrator 114 of the communication device 102 employs the communication device 102 to set the communication session restrictions for the user 118 of the mobile communication device 110. For example, the administrator 114 employs one or more websites to set the communication session restrictions. The application server component 106 in one example accesses the communication session restrictions set by the administrator 114 of the communication device 102 from the website. The administrator 114 in one example shares a relationship with the user 118 of the mobile communication device. For example, the administrator 114 is a parent or a manager of the user 118. The administrator 114 and the user 118 in one example share a billing relationship for the communication device 102 and the mobile communication device 110. The communication devices 102 and 104 in one example comprise one or more of a landline phone, a mobile phone, a personal digital assistant, and a computer.

The application server component 106 in one example stores the communication session restrictions set by the administrator 114 of the communication device 102. The application server component 106 in one example comprises an instance of a recordable data storage medium 112. The application server component 106 in one example employs the communication session restrictions to advise the network component 108 for control of the connection of the communication session of the mobile communication device 110. For example, upon an indication that the communication session involves the mobile communication device 110, the application server component 106 checks the communication session restrictions to determine if the communication session restrictions allow the communication session. The application server component 106 in one example advises the network component 108 to allow or reject the communication session.

The network component 108 controls the connection of the communication session through employment of advice from the application server component 106. Where the application server component 106 allows the communication session, the network component 108 connects the communication device 104 (e.g., a mobile phone) and the mobile communication device 110 in the communication session. Where the communication device 104 comprises a device other than a mobile phone, the network component 108 connects the communication session between the mobile communication device 110 and the communication device 104 through another network (not shown). For example, where the communication device comprises a landline telephone, the other network comprises a public switched telephone network (“PSTN”). Where the application server component 106 rejects the communication session, the network component 108 does not connect the communication device 104 and the mobile communication device 110 in the communication session. The network component 108 in one example comprises one or more of a call state control function (“CSCF”) and a mobile switching center (“MSC”). The network component 108 in one example receives an indication of the communication session from one or more of the communication device 104 and the mobile communication device 110.

Where the application server component 106 advises the network component 108 to allow the communication session, the network component 108 connects the communication device 104 and the mobile communication device 118 in the communication session. Where the communication session restrictions comprise the time limit restriction, the application server component 106 in one example sends a warning of a communication session termination through the network component 108 to the mobile communication device 110 when a time limit of the time limit restriction is about to expire. In one example, the user 118 of the communication device 110 ends the communication session. In another example, the user 118 of the communication device sends a request to continue the communication session through the network component 108 to the application server 106. The application server component 108 in one example sends a notification of the request to the administrator 114. In one example, the application server component 106 advises the network component 108 to allow the communication session to continue. In another example, the application server component 106 advises the network component 108 to disconnect the communication session between the communication device 104 and the mobile communication device 110.

Where the application server component 106 advises the network component 108 to reject the communication session, the network component 108 does not allow a connection of the communication device 104 with the mobile communication device 104 in the communication session. In one example, where the communication session restrictions comprise the session limit restriction, the user 118 employs the mobile communication device 110 to attempt to send or receive one or more of the phone call, the email, the instant message, the short message service message, and the multimedia message. If the one or more of the phone call, the email, the instant message, the short message service message, and the multimedia message exceeds a session limit of the session limit restriction, the application server component 106 advises the network component 108 to reject the communication session. Where the communication session comprises an incoming call from the user 116 of the communication device 104, the application server component 106 in one example sends the incoming call to a messaging component of the mobile communication device 110. For example, the user 116 employs the communication device 104 to leave a voice message for the user 118 of the mobile communication device 110. The application server component 106 in one example converts the voice message into a short service message or an email for the mobile communication device 110.

In another example, where the communication session restrictions comprise the user limit restriction, the user 116 employs the communication device 104 to attempt the communication session with the user 118 of the mobile communication device 110 or the user 118 employs the mobile communication device 110 to attempt the communication session with the user 116 of the communication device 104. If the application server component 106 checks the user limit restriction and determines that the user 118 is not allowed to communicate with the user 116, the application server component 106 advises the network component 108 to reject the communication session.

In yet another example, where the application server component 106 advises the network component 108 to reject the communication session, the user 118 employs the mobile communication device 110 to send a request to allow the communication session through the network component 108 to the application server component 108. The application server component 108 in one example sends a notification of the request to the administrator 114. In one example, the application server component 106 advises the network component 108 to allow the communication session. For example, the request comprises an emergency request. In another example, the application server component 106 advises the network component 108 to reject the communication session.

In still another example, where the communication session restrictions comprise the website limit restriction, the user 118 employs the mobile communication device 110 to attempt to connect to a website. If the application server component 106 checks the website limit restriction and determines that the user 118 is not allowed to connect to the website, the application server component 106 advises the network component 108 to reject the communication session.

In another example, where the application server component 106 advises the network component 108 of an allowance or a rejection of the communication session, the application server component 106 in one example sends one or more notifications of the allowance or the rejection to the administrator 114. For example, the administrator 114 employs the notifications to monitor one or more communication sessions of the user 118 of the mobile communication device 110. The notifications in one example comprise one or more of an email, a phone call, website access, an instant message, a short message service message, and a multimedia message.

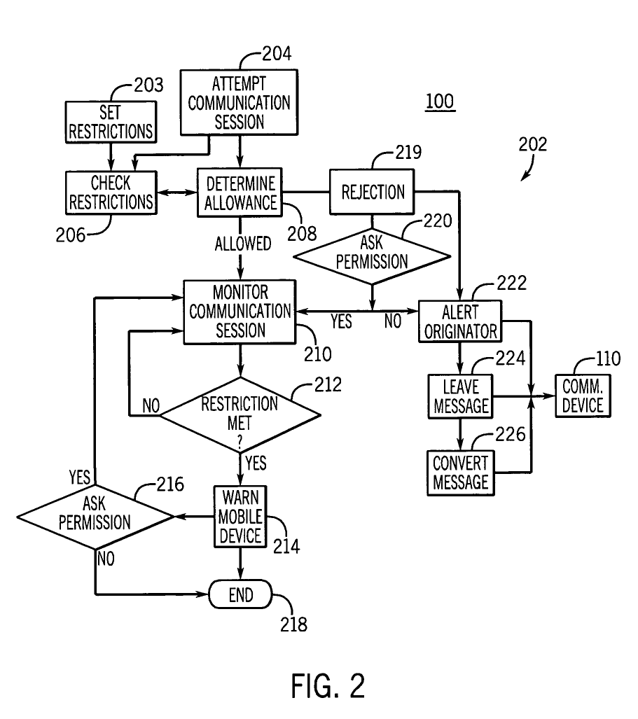

Referring to FIGS. 1-2, exemplary logic 202 serves to allow the application server component 106 of the apparatus 100 to employ the communication session restrictions to advise the network component 108 for control of the communication session of the mobile communication device 110, as described herein. The apparatus 100 can allow or reject a connection of the communication session through employment of the communication session restrictions. The logic 202 employs one or more steps, for example, STEPS 203, 204, 206, 208, 210, 212, 214, 216, 218, 219, 220, 222, 224, and 226.

The user 118 in one example employs the mobile communication device 110 to attempt to conduct the communication session with the user 116 of the communication device 104. The application server component 106 in one example checks the communication session restrictions to determine if the communication session restrictions allow the communication session. The application server component 106 advises the network component 108 to allow or the reject the communication session between the mobile communication device 110 and the communication device 104.

The administrator 114 employs the communication device 102 to set the communication session restrictions for the user 118 of the mobile communication device 110 at the application server component 106. For example, the administrator 114 logs onto a website connected to the application server component 106 to set the communication session restrictions in STEP 203 and then proceeds to STEP 204 any time a communication session is requested by the mobile communication device 110.

The user 118 in one example employs the mobile communication device 110 to make an attempt to conduct the communication session with the user 114 of the communication device 104. For example, the user 118 employs the mobile communication device 110 to attempt to send or receive one or more of the phone call, the email, the instant message, the short message service message, and the multimedia message, and STEP 204 proceeds to STEP 206. Upon the attempt to conduct the communication session, the application server component 106 checks one or more communication session restrictions, then STEP 206 proceeds to STEP 208. The application server component 106 in one example checks the one or more to make a determination of allowance of the communication session.

If the determination of allowance comprises an allowance of the communication session, the application server component 106 advises the network component 108 to connect the mobile communication device 110 and the communication device 104 in the communication session, then STEP 208 proceeds to STEP 210. The application server component 106 in one example monitors the communication session to determine if the communication session meets one or more of the communication session restrictions. For example, the application server component 106 monitors the communication session to make a determination of continuation of the communication session, then STEP 210 proceeds to STEP 212. In one example, where the communication session restrictions comprise a time limit restriction, if the communication session is within a time limit of the time limit restriction, the application server 106 continues to monitor the communication session and STEP 212 proceeds back to STEP 210.

In another example, the communication session restrictions comprise the time limit restriction. If the communication session nears the time limit of the time limit restriction, then the application server component 106 sends a warning of communication session termination to the mobile communication device 110 and STEP 212 proceeds to STEP 214. If the communication session exceeds the time limit, then STEP 214 proceeds to STEP 218. If the user 118 employs the mobile communication device 110 to send a request to continue the communication session 216 to the application server component 106, then STEP 214 proceeds to STEP 216. In one example, the application server component 106 allows the communication session to continue and STEP 216 proceeds back to STEP 210. In another example, the application server component 106 disconnects the communication session between the user 118 of the mobile communication device 110 and the user 114 of the communication device 104, and STEP 216 proceeds to STEP 218.

Where the determination of allowance comprises a rejection of a communication session, the application server component 106 advises the network component 108 to reject a connection and STEP 208 proceeds to STEP 219. If the user 118 employs the mobile communication device 110 to send a request to continue the communication session to the application server component 106, then STEP 219 proceeds to STEP 220. In one example, if the application server component 106 allows a connection of the communication session, then STEP 220 proceeds to STEP 210. In another example, if the application server component 106 rejects the request to connect the communication session, then STEP 220 proceeds to STEP 222 just as if the user had not sent the request to continue the communication session.

Where the communication session comprises an incoming call from the communication device 104 and the application server component 106 rejects the request to connect the incoming call, the application server component 106 in one example sends an alert to the communication device 104, and STEP 222 proceeds to STEP 224. For example, the application server component 106 sends the incoming call to a messaging component of the mobile communication device 110. The user 116 in one example employs the communication device 110 to leave a voice message for the user 118 of the mobile communication device 110 with the messaging system. In one example, the exemplary logic 202 is complete. In another example, the application server component 106 converts the voice message into a text-based message for the user 118 of the mobile communication device 110, and STEP 224 proceeds to STEP 226. The text-based message in one example comprises one or more of an email, a short message service message, and an instant message.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. Examples of a computer-readable signal-bearing medium for the apparatus 100 comprise the recordable data storage medium 112 of the application server component 106. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
an application server component that serves to maintain one or more communication session restrictions set by one or more administrators for one or more mobile communication devices;
wherein the application server component employs one or more of the one or more communication session restrictions to advise one or more network components for control of one or more connections of one or more communication sessions for one or more of the one or more mobile communication devices.

2. The apparatus of claim 1, wherein the one or more administrators employ one or more websites to set the one or more communication session restrictions;
wherein the application server component maintains the one or more of the one or more communication session restrictions set by the one or more administrators with the one or more websites.

3. The apparatus of claim 1, wherein the one or more network components comprise a network component, wherein the one or more connections of the one or more communication sessions for the one or more of the one or more mobile communication devices comprises a connection of a communication session for a mobile communication device;
wherein upon receipt of an indication of the communication session that involves the mobile communication device, the application server component checks one or more of the one or more communication session restrictions;
wherein if the one or more of the one or more communication session restrictions allows the connection of the communication session for the mobile communication device, then the application server component advises the network component to allow the connection of the communication session for the mobile communication device.

4. The apparatus of claim 3, wherein the application server component advises the network component to send a warning of a communication session termination to the mobile communication device.

5. The apparatus of claim 4, wherein the one or more administrators comprise an administrator, wherein the application server component receives a request to continue the communication session from the mobile communication device;
wherein the application server component notifies the administrator of the request to continue the communication session.

6. The apparatus of claim 1, wherein the one or more network components comprise a network component, wherein the one or more connections of the one or more communication sessions for the one or more of the one or more mobile communication devices comprises a connection of a communication session for a mobile communication device;
wherein upon receipt of an indication of the communication session that involves the mobile communication device, the application server component checks the one or more of the one or more communication session restrictions;
wherein if the one or more of the one or more communication session restrictions does not allow the connection of the communication session for the mobile communication device, then the application server component advises the network component to reject the connection of the communication session for the mobile communication device.

7. The apparatus of claim 6, wherein the one or more administrators comprise an administrator, wherein the application server component receives a request to allow the communication session from the mobile communication device;
wherein the application server component notifies the administrator of the request to allow the communication session.

8. The apparatus of claim 7, wherein the request comprises an emergency request, wherein the application server component allows the communication session for the mobile communication device.

9. The apparatus of claim 6, wherein the communication session comprises an incoming call, wherein the application server component sends the incoming call to a messaging component of the mobile communication device.

10. The apparatus of claim 9, wherein an originator of the incoming call leaves a voice message for a user of the mobile communication device, wherein the application server component converts the voice message to a short message service message or an email;
wherein the application server component sends the short message service message or the email through the network component to the mobile communication device.

11. The apparatus of claim 1, wherein the application server component sends one or more notifications of the one or more connections of the one or more communication sessions to the one or more administrators.

12. The apparatus of claim 1, wherein the application server component serves to maintain the one or more communication session restrictions for the one or more mobile communication devices, wherein the one or more communication sessions of the one or more mobile communication devices comprise one or more of an email, a phone call, website access, an instant message, and a short message service message.

13. The apparatus of claim 1, wherein the one or more of the one or more communication session restrictions comprise one or more of a time limit, a session limit, a user limit, and a website limit;
wherein the application server component employs the one or more of the time limit, the session limit, the user limit, and the website limit to advise the one or more network components for control of the one or more connections of the one or more communication sessions for the one or more of the one or more mobile communication devices.

14. A method, comprising the steps of:
maintaining one or more communication session restrictions set by one or more administrators for one or more mobile communication devices; and
advising one or more network components for control of one or more connections of one or more communication sessions for one or more of the one or more mobile communication devices through employment of one or more of the one or more communication session restrictions.

15. The method of claim 14, wherein the one or more network components comprise a network component, wherein the one or more connections of the one or more communication sessions for the one or more of the one or more mobile communication devices comprises a connection of a communication session for a mobile communication device;
wherein the step of advising the network component for control of the connection of the communication session for the mobile communication device through employment of the one or more of the one or more communication session restrictions comprises the steps of:
advising the network component to allow the connection of the communication session for the mobile communication device; and
monitoring the communication session through employment of the one or more of the one or more communication session restrictions to determine an allowance of continuation of the communication session.

16. The method of claim 15, wherein the step of monitoring the communication session through employment of the one or more of the one or more communication session restrictions to make the determination of the conclusion of the communication session comprises the steps of:
determining if one or more conditions of the one or more of the one or more communication session restrictions are met during the one or more communication sessions; and
advising the network component to send a warning of a communication session termination to the mobile communication device if one or more of the one or more conditions are met.

17. The method of claim 14, wherein the one or more network components comprise a network component, wherein the one or more connections of the one or more communication sessions for the one or more of the one or more mobile communication devices comprises a connection of a communication session for a mobile communication device:
wherein the step of advising the network component for control of the connection of the communication session for the mobile communication device through employment of the one or more of the one or more communication session restrictions comprises the steps of:
advising the network component to reject the connection of the communication session for the mobile communication device; and
allowing for receipt of a request to continue the communication session from the mobile communication device.

18. The method of claim 17, wherein the one or more administrators comprise an administrator, wherein the step of allowing for receipt of the request to continue the communication session from the mobile communication device comprises the steps of:
receiving the request from the mobile communication device;
asking the administrator for permission to allow the communication session to continue; and
allowing the one or more communication sessions to continue.

19. The method of claim 14, wherein the step of maintaining the one or more communication session restrictions set by the one or more administrators for the one or more mobile communication devices comprises the steps of:
allowing access to one or more websites by the one or more administrators to set one or more of the one or more communication session restrictions; and
receiving the one or more of the one or more communication session restrictions from the one or more websites.

20. An article, comprising:
one or more computer-readable signal-bearing media;
means in the one or more media for maintaining one or more communication session restrictions set by one or more administrators for one or more mobile communication devices; and
means in the one or more media for advising one or more network components for control of one or more connections of one or more communication sessions for one or more of the one or more mobile communication devices through employment of one or more of the one or more communication session restrictions.
